(19) United States
(12) Patent Application Publication
(10) Pub. No.: US 2023/0422098 A1
(43) Pub. Date: Dec. 28, 2023

(54) PROVIDING BURST END TIME IN TIME SENSITIVE COMMUNICATION ASSISTANCE INFORMATION

(71) Applicant: Telefonaktiebolaget LM Ericsson (PUBL), Stockholm (SE)

(72) Inventors: John Walter DIACHINA, GARNER, NC (US); Torsten DUDDA, WASSENBERG (DE); Marilet DE ANDRADE JARDIM, KISTA (SE); Zhenhua ZOU, SOLNA (SE)

(21) Appl. No.: 18/249,792

(22) PCT Filed: Oct. 20, 2021
(86) PCT No.: PCT/EP2021/079143

§ 371 Date: Apr. 20, 2023

Related U.S. Application Data
(60) Provisional application No. 63/094,984, filed on Oct. 22, 2020.

(51) Int. Cl. H04W 28/12; H04W 72/52; H04W 72/0446

(52) U.S. Cl. CPC H04W 28/12; H04W 72/52; H04W 72/0446

(57) ABSTRACT

A method by a radio access network node includes receiving, from a network node, information indicating a burst end time (BET) for a first burst of data traffic within a traffic flow.

### TECHNICAL FIELD

The present disclosure relates, in general, to wireless communications and, more particularly, systems and methods for providing Burst End Time (BET) in Time Sensitive Communication Assistance Information (TSCAI).

### BACKGROUND

In Release 17 (Rel-17), 5^{th} Generation (5G) systems continue to be enhanced to support inter-working with Time Sensitive Communications (TSC) (involving Time Sensitive Networking (TSN) and non-TSN services) to address the key concept of using 5G based wireless operation in the context of factory automation (i.e. 5G inter-working with Ethernet-based or Internet Protocol (IP) based industrial communication networks).

In RAN2 #105, it was noted that the knowledge of a TSN traffic pattern is useful for the gNodeB (gNB) to allow it to more efficiently schedule radio resources for TSN traffic using Configured Grants (radio resources allocated for periodic uplink traffic), Semi-Persistent Scheduling (radio resources allocated for periodic downlink traffic) or dynamic grants (used for aperiodic uplink or downlink traffic). As such, Time Sensitive Communication Assistance Information (TSCAI) has been specified and consists of the information shown in Table 1.

TABLE 1
TSC Assistance Information

| Assistance | |
|---|---|
| Information | Description |
| Flow Direction | The direction of the TSC flow (uplink or downlink). |
| Periodicity | It refers to the time period between start of two |
| | bursts. |
| Burst Arrival time | The latest possible time when the first packet of the |
| | data burst arrives at either the ingress of the RAN |
| | (downlink flow direction) or egress interface of the |
| | UE (uplink flow direction). |

See, 3GPP TS 23.501 v. 16.6.0, table 5.27.2-1. Note that, in Rel 17, TSCAI applies both for TSN and non-TSN time-sensitive services. As used herein, the term burst may include one or multiple packets to be included in a single MAC PDU. The multiple packets in the burst have common attributes such as, for example, PER. Each packet may include time sensitive communication.

Certain problems exist for efficient handling of available radio resources, based on the Burst Arrival Time.

### SUMMARY

Certain aspects of the present disclosure and their embodiments may provide solutions to these or other challenges. For example, according to certain embodiments, methods and systems are provided that enable a 5G system to more efficiently assign radio resources for relaying periodic TSC traffic (packets) over the radio interface. According to certain embodiments, for example, a Burst Arrival Time (BAT) and a Burst End Time (BET) are provided and applied for the first burst of a periodic burst cycle. Then the burst period information (i.e., the Periodicity attribute of Table 1) is used to determine BAT and BET values for all subsequent burst periods.

According to certain embodiments, a method by a wireless device includes receiving, from a network node, information indicating a BET for a first burst of data traffic within a traffic flow.

According to certain embodiments, a wireless device is adapted to receive, from a network node, information indicating a BET for a first burst of data traffic within a traffic flow.

According to certain embodiments, a method by a network node includes determining information indicating a BET for a burst of data traffic within a traffic flow and transmitting the information to a radio access network node.

According to certain embodiments, a network node is adapted to determine information indicating a BET for a burst of data traffic within a traffic flow and transmit the information to a radio access network node.

Certain embodiments may provide one or more of the following technical advantages. For example, one technical advantage may be that when allocating downlink or uplink DRB resources with knowledge of BET, certain embodiments enable the gNB to experience increased flexibility regarding where (in the time domain) it can allocate the required DRB resources compared to the case where it relies on using a “drop dead time” to determine the earliest point in time where it can allocate the required DRB resources. In other words, with access to the BET attribute the gNB may be provided with knowledge of a greater time interval over which it can allocate the required DRB resources while still ensuring the target PDB and PER attributes of the QoS flow are satisfied. This may lead to increased efficiency for the gNB when managing the available radio resources.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1

FIG. 2 illustrates an example wireless network, according to certain embodiments;

FIG. 3 illustrates an example network node, according to certain embodiments;

FIG. 4 illustrates an example wireless device, according to certain embodiments;

FIG. 5 illustrate an example user equipment, according to certain embodiments;

FIG. 6 illustrates a virtualization environment in which functions implemented by some embodiments may be virtualized, according to certain embodiments;

FIG. 7 illustrates a telecommunication network connected via an intermediate network to a host computer, according to certain embodiments;

FIG. 8 illustrates a generalized block diagram of a host computer communicating via a base station with a user equipment over a partially wireless connection, according to certain embodiments;

FIG. 9 illustrates a method implemented in a communication system, according to one embodiment;

FIG. 10 illustrates another method implemented in a communication system, according to one embodiment;

FIG. 11 illustrates another method implemented in a communication system, according to one embodiment;

FIG. 12 illustrates another method implemented in a communication system, according to one embodiment;

FIG. 13 illustrates an example method by a wireless device, according to certain embodiments;

FIG. 14 illustrates an exemplary virtual computing device, according to certain embodiments;

FIG. 15 illustrates an example method by a radio access network (RAN) node, according to certain embodiments;

FIG. 16 illustrates another exemplary virtual computing device, according to certain embodiments;

FIG. 17 illustrates an example method by a network node, according to certain embodiments;

FIG. 17 illustrates another exemplary virtual computing device, according to certain embodiments;

FIG. 19 illustrates another example method by a radio network node, according to certain embodiments;

FIG. 20 illustrates another exemplary virtual computing device, according to certain embodiments;

FIG. 21 illustrates another example method by a network node, according to certain embodiments; and

FIG. 22 illustrates another exemplary virtual computing device, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operation and Maintenance (O&M), Operations Support System (OSS), Self Organizing Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet; mobile terminals, smart phone, laptop embedded equipped (LEE), laptop mounted equipment (LME), Unified Serial Bus (USB) dongles, UE category M1, UE category M2, Proximity Services UE (ProSe UE), Vehicle-to-Vehicle UE (V2V UE), Vehicle-to-Anything UE (V2X UE), etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems are provided that enable a 5G system to more efficiently assign radio resources for relaying periodic TSC traffic (packets) over the radio interface. According to certain embodiments, for example, a BAT and a BET are provided and applied for the first burst of a periodic burst cycle. Then the burst period information, as described above with respect to Table 1, may be used to determine BAT and BET values for all subsequent burst periods.

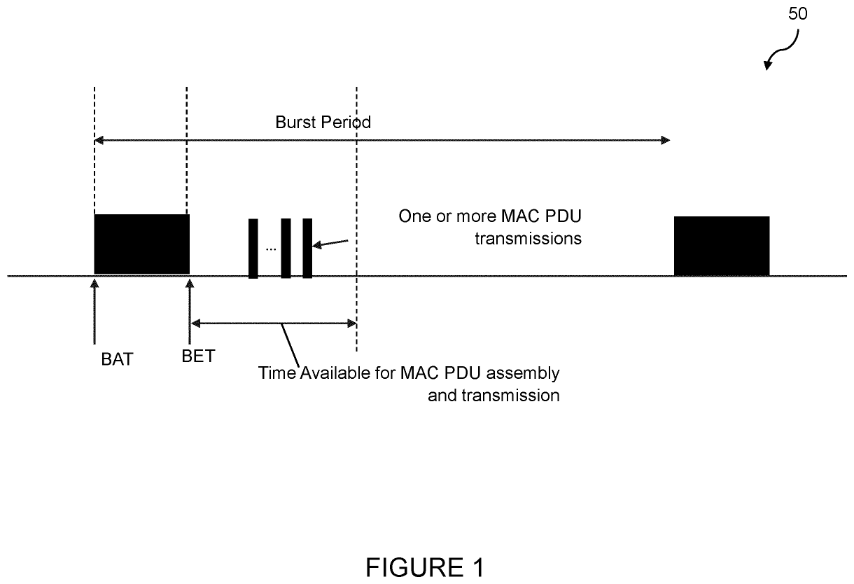

FIG. 1 illustrates an example 50 demonstrating MAC PDU assembly and transmission time, according to certain embodiments. For example, FIG. 1 demonstrates that the data (one or more packets) to be transmitted using any given instance of a periodic radio resource is received by a gNB (downlink) or UE (uplink) within a burst, which is the time span bounded by the BAT and the BET.

According to various particular embodiments, methods and systems for allocation of DRB based on BAT and BET are provided for the case where:
A set of one or more packets that have a common Traffic Class and compatible periodicity are aggregated for delivery through the 5G system using a specific QoS flow.
The set of one or more packets received by the gNB (downlink traffic) or UE (uplink traffic) arrive during a fixed time span (i.e. the portion of the Burst period determined using BAT and BET as shown in FIG. 1) and are aggregated into a common MAC PDU for transmission over the radio interface.
Knowledge of this fixed time span can be provided to a gNB by supplementing BAT with a new TSCAI parameter referred to as BET.
Reception of BET therefore allows a gNB to determine the latest point in time where UE or gNB can receive a packet for inclusion in each instance of a periodic radio resource (uplink or downlink respectively) used to support transmission of packets associated with a given QoS flow.

In a particular embodiment, for example, the BET is the latest time when no more data from the burst can arrive at either the ingress of the RAN (downlink flow direction) or egress interface of the UE (uplink flow direction) during the first burst periodicity. Note that this is different from the definition that BET is the latest time when the last packet from the burst arrives, which does not count for the time to transmit the packet itself which is not negligible. This means that even if there is a single packet in the burst, BAT and BET are not equivalent.

In a further particular embodiment, the BET is calculated as BAT+burst time duration+maximum delay between 5G ingress to RAN node, i.e., Core Network (CN) PDB. In Rel. 16, the burst time duration is calculated based on IEEE 802.1Q Per-Stream Filtering and Policing (PSFP) information applicable to the gate open duration, which determine and limit when packets may arrive for one or more for TSN streams. In summary, in a particular embodiment, the BET, as determined by a core network function and as indicated to the RAN, may be composed of:
Latest time when last bit of the last packet in a burst is estimated to arrive at the 5G system ingress point (this can correspond to the IEEE 802.1Q PSFP gate closing time);
Plus, the time it is estimated to take for the packet to arrive at the RAN, i.e. CN PDB in DL, and UE-DS-TT residence time in UL.
Plus, potential jitter on CN or transport interfaces, in order to make the BET indicate the latest point in time when RAN expects packets to arrive, considering also potential jitter.

When allocating downlink or uplink DRB resources with knowledge of BET, the gNB experiences increased flexibility regarding where (in the time domain) the gNB can allocate the required DRB resources compared to the case where the gNB relies on using a “drop dead time” to determine the earliest point in time where the gNB can allocate the required DRB resources. In other words, with access to the BET attribute, the gNB is provided with knowledge of a greater time interval over which the gNB can allocate the required DRB resources while still ensuring the target PDB and PER attributes of the QoS flow are satisfied. This leads to increased efficiency for the gNB when managing the available radio resources.

In some aspects, a radio access network node such as, for example, a gNB, receives, from a further network node, information indicating a BET for a first burst of data traffic within a traffic flow. The further network node may be a CN node or comprise a node operating a CN function. Based on the information indicating the BET for the first burst of data traffic, the radio access network node schedules at least one radio resource for a transmission to a wireless device. Thus, the uplink or downlink scheduling performed by the gNB uses the BET to efficiently schedule data after the first burst of data traffic.

In a particular embodiment, the gNB schedules or pre-schedules recurring/periodic DRB resources (configured grant for the uplink, SPS for the downlink) used for the burst exactly at the BET. In another embodiment, the gNB does this at any time after the BET and before the latest time at which the one or more packets are to be delivered according the PDB and the expected transmission time of the packets. For example, the gNB may perform DRB resource scheduling in the interval:
[BET,EarliestPacketArrivalOfBurst+PDB−transmissionTime]

The gNB may chose a transport block size such that it fits all packets received in the burst. Aggregating all packets received for a given burst into a single transport block leads to higher spectral efficiency compared to transmitting the packets one by one as they arrive as compared to each packet being mapped to a separate MAC PDU that is then mapped to a corresponding transport block.

In some aspects, the BET addresses a problem with the existing TSCAI in that there is no indication regarding when the gNB and/or user equipment (UE) can expect that no more data for the burst occurring within any given instance of a burst period will arrive (see FIG. 1). Without this information, a gNB is forced to identify a latest point in time (i.e. a “drop dead time”) for accepting packets to be aggregated into the next Medium Access Control Protocol Data Unit (MAC PDU) to be sent using the next periodic Data Radio Bearer (DRB) resource of the corresponding Quality of Service (QoS) flow. Note that all packets received within a burst spanning the time from Burst Arrival Time (BAT) to the “drop dead time” are aggregated for inclusion in a common MAC PDU. When forced to allocate downlink or uplink DRB resources according to a “drop dead time” the gNB experiences increased constraints regarding where (in the time domain) it can allocate the DRB resources while still ensuring the target Packet Delay Budget (PDB) and Packet Error Rate (PER) attributes of the QoS flow are satisfied. See, 3GPP TS 23.501 v. 16.6.0, section 5.7.3. This leads to a reduced efficiency for the gNB when managing the available radio resources for MAC PDU transmission.

While the Reason for Change provided by S2-2002787 addressed the same problem described herein, it identified a different solution:
The current definition of Burst Arrival time is unclear i.e. whether it is at the beginning or end of burst. gNB uses Burst Arrival time to determine when it receives all the payload (Ethernet frame/frames) for inclusion in the next periodic instance of the DRB resource used in support of the corresponding TSN stream or aggregated flow of TSN streams. In this way, RAN knows until when to wait for data in burst to send aggregated data in a single PDU. Therefore, it is beneficial for RAN to obtain from TSCAI a burst arrival time that refers to the end of the burst rather than the beginning of the burst.

Related information is found in S2-2002787 TSCAI Burst Arrival Time clarification, CR to 23.501. Additionally, TR 23.700-20 did not address introduce a new TSCAI parameter and did not allow for the possibility of taking into account the value of jitter, e.g. see TR 23.700-20 version 1.0.0.

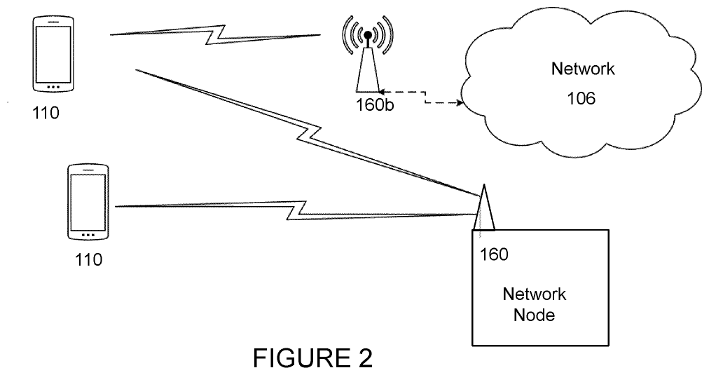

FIG. 2 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 only depicts network 106, network nodes 160 and 160b, and wireless devices 110. In some examples, network node 160b may be a radio access network node, e.g. a radio base station (e.g. gNB) or a component part of a radio base station. The network 106 may comprise a core network node, or the functionality of a core network node. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

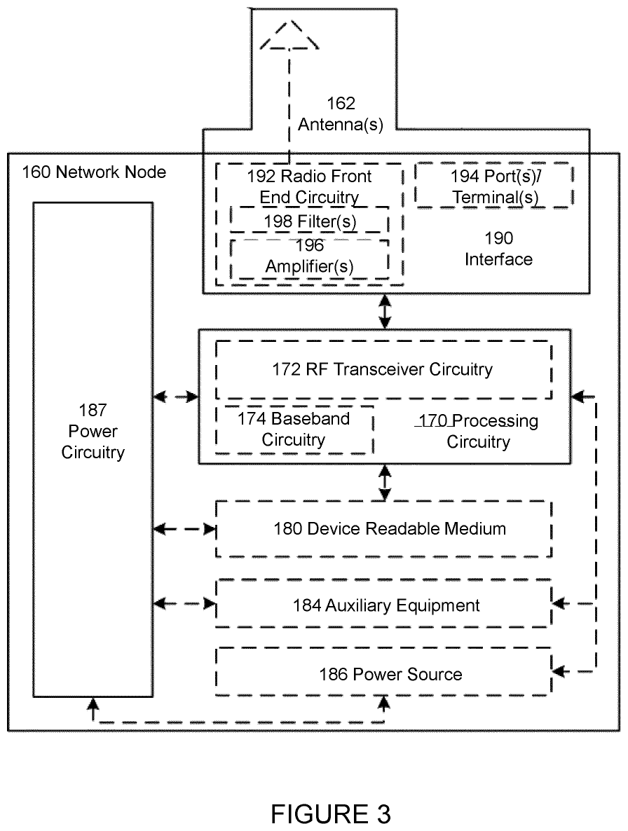

FIG. 3 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 3, network node 160 includes processing circuitry 170, device readable medium 180, interface 190, auxiliary equipment 184, power source 186, power circuitry 187, and antenna 162. Although network node 160 illustrated in the example wireless network of FIG. 3 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, hoards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 3 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

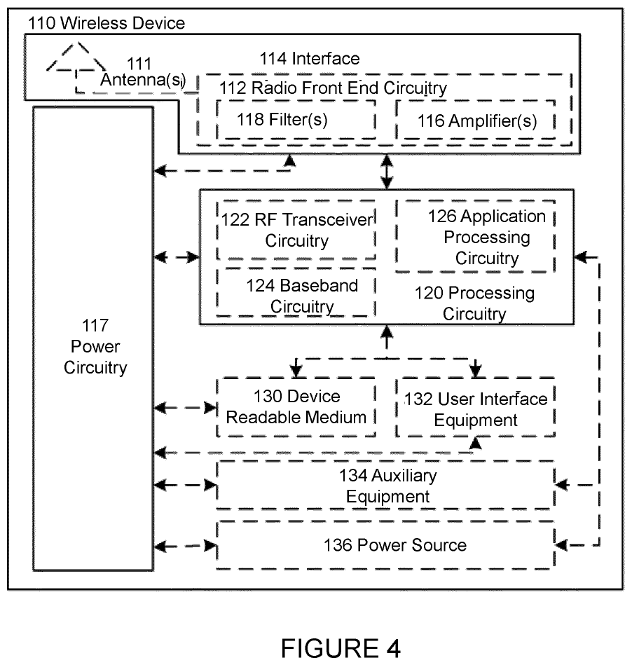

FIG. 4 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

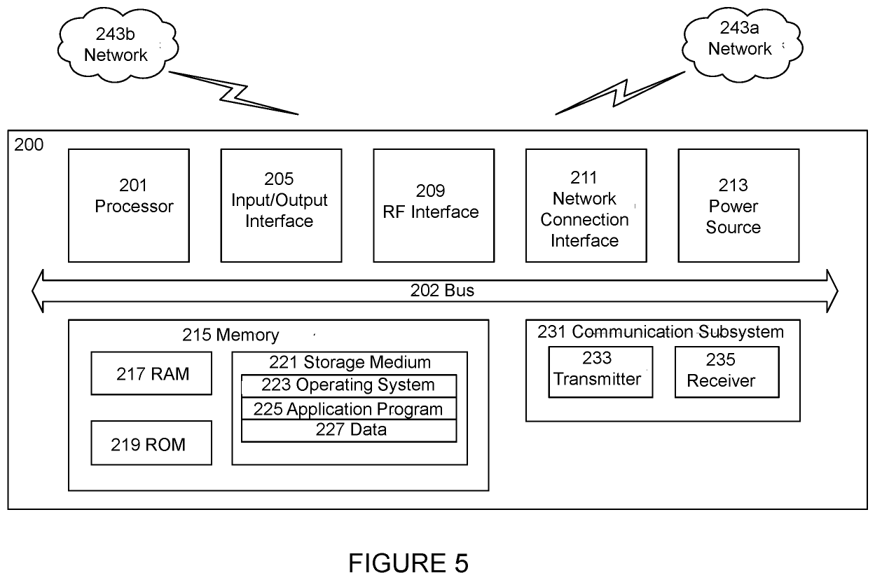

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 3, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 5 is a UE, the components discussed herein are equally applicable to a wireless device, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UF 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243h may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243h may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

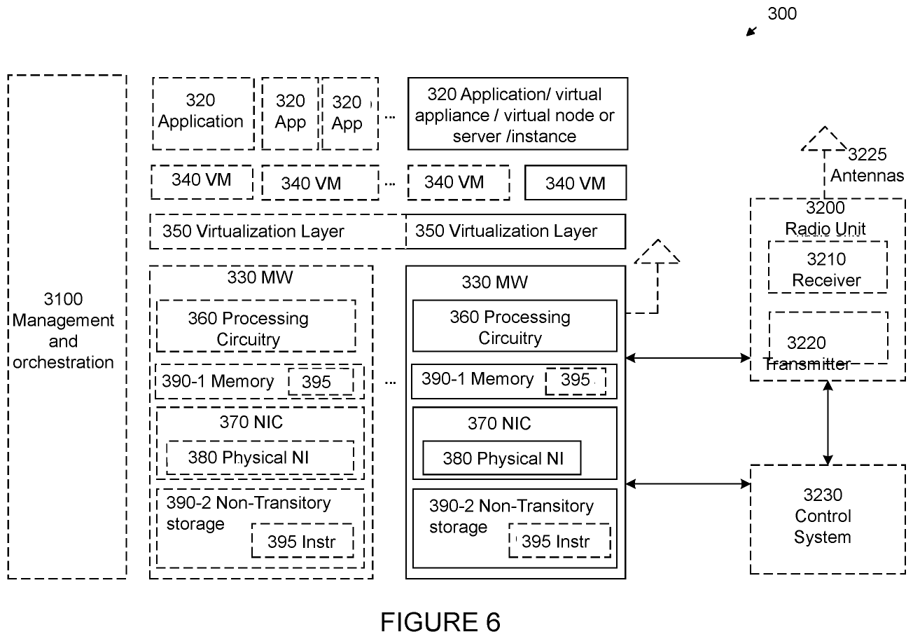

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 6.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

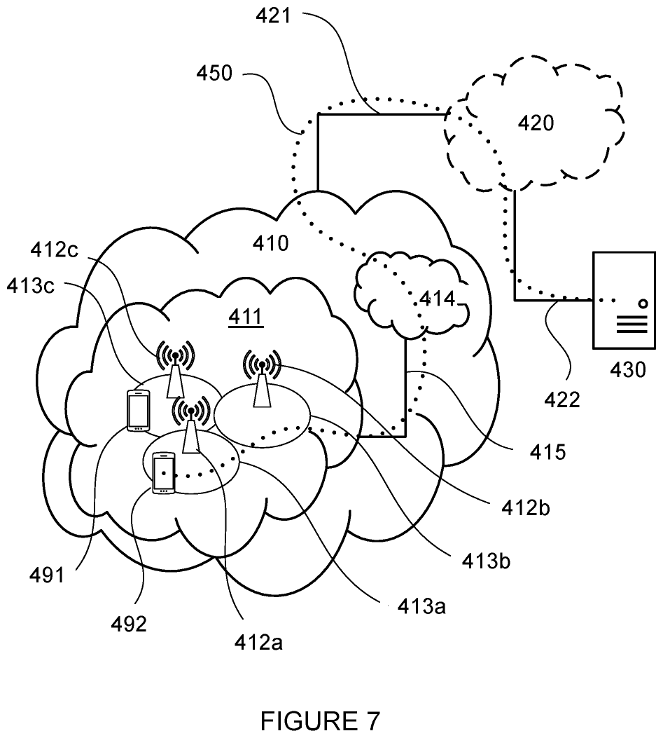

FIG. 7 illustrates a telecommunication network connected via an intermediate network to a host computer in accordance with some embodiments.

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

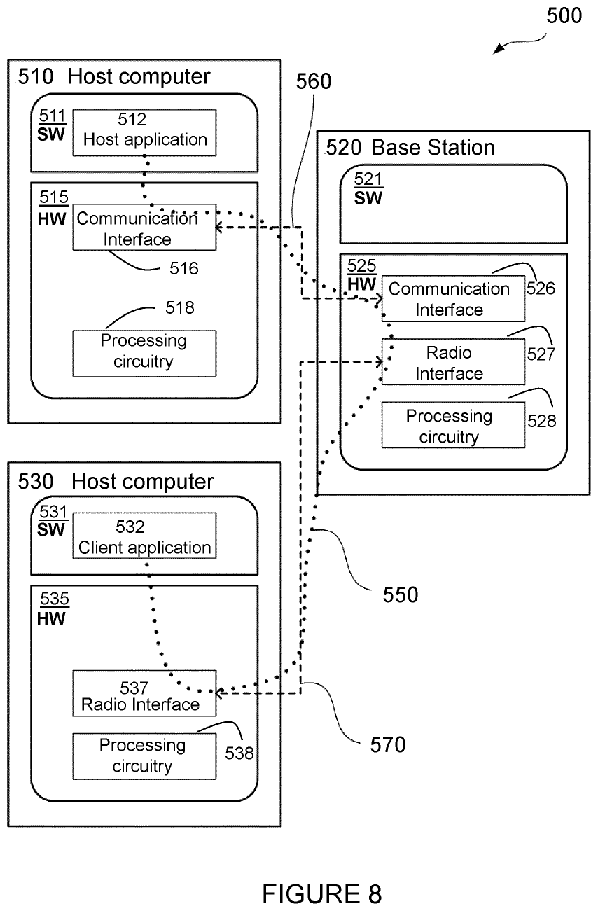

FIG. 8 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 7, respectively. This is to say, the inner workings of these entities may be as shown in FIG. 8 and independently, the surrounding network topology may be that of FIG. 7.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

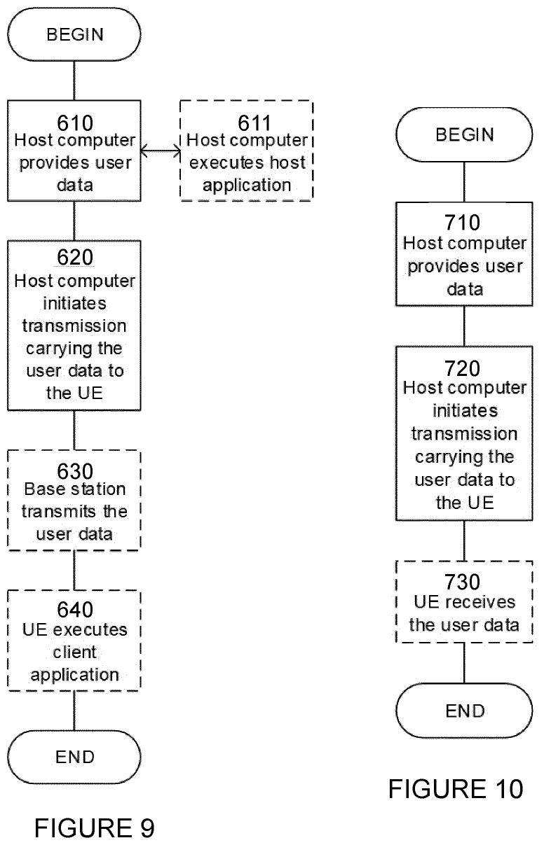

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

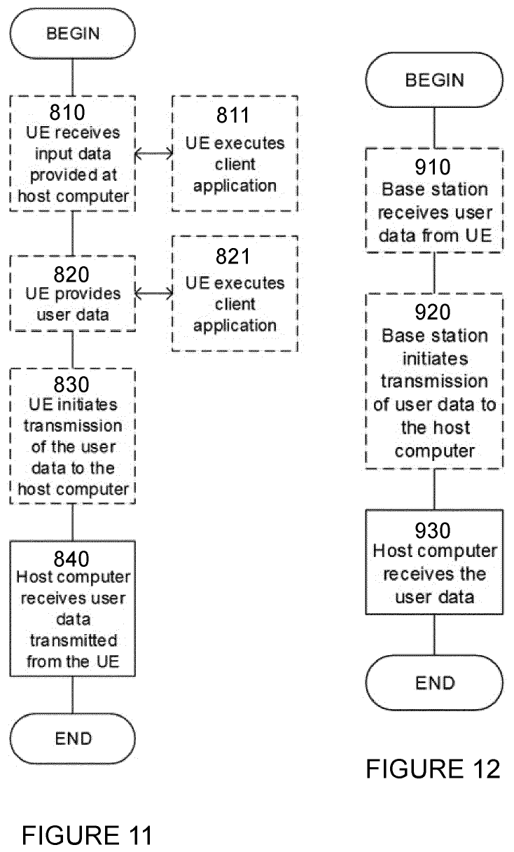

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

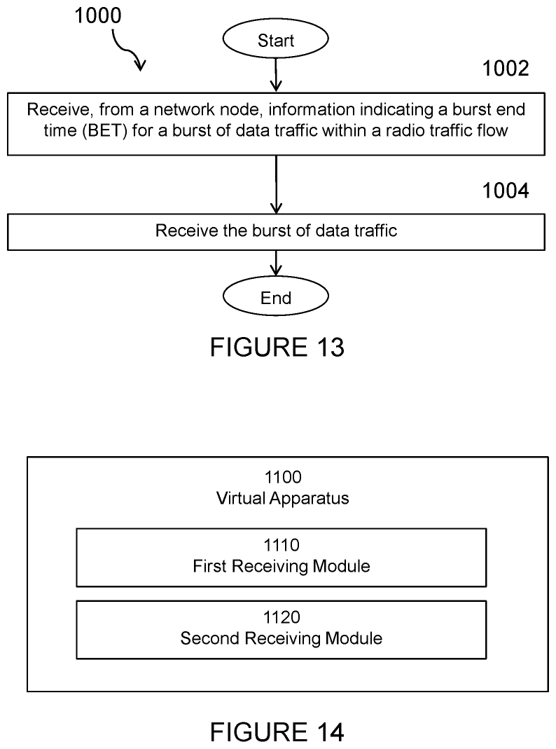

FIG. 13 depicts a method 1000 by a wireless device 110, according to certain embodiments. At step 1002, the wireless device receives, from a network node 160 (such as, for example, a RAN node), information indicating a BET for a burst of data traffic within a traffic flow or radio traffic flow. At step 1004, the wireless device receives the burst of data traffic.

In a particular embodiment, the wireless device aggregates packets received within the burst of data traffic.

In a particular embodiment, the information comprises TSCAI associated with a TSC. In a further particular embodiment, the TSC is associated with at least one TSN service.

In a particular embodiment, the traffic or radio traffic flow includes a plurality of bursts of data traffic, and the burst of data traffic for which the BET is indicated is a first burst of data traffic within the plurality of bursts of data traffic. In a further particular embodiment, the plurality of bursts of data traffic make up a periodic burst cycle. In a further particular embodiment, the traffic or radio traffic flow comprises a Quality of Service flow. In a further particular embodiment, based on the BFT for the first burst of data traffic, the wireless device determines a BET for each burst of data traffic within the plurality of bursts of data traffic.

In a particular embodiment, the BET is a latest time when no additional packets can arrive at an ingress interface of the network node for transmission on the downlink or an egress interface of the wireless device for transmission on the uplink.

In a particular embodiment, the BET is a latest time when a last packet in the burst is estimated to arrive at the radio network system and a time duration estimated for the last packet to arrive at the network node.

In a particular embodiment, the BET further comprises an amount of time associated with jitter.

In a particular embodiment, the wireless device receives, from a network node such as, for example, a RAN node, scheduling information comprising at least one radio resource for receiving the burst of data traffic based on the BET.

In a particular embodiment, based on the information comprising the BET, the wireless device determines a latest point in time when a packet is to be included in a transmission associated with the at least one radio resource.

In a particular embodiment, the at least one radio resource for the burst of data traffic within the traffic or radio traffic flow is scheduled based on the information at a time corresponding to the BET.

In a particular embodiment, the at least one radio resource for the burst of data traffic within the traffic or radio traffic flow is scheduled based on the information at a time after the BET.

In a particular embodiment, the at least one radio resource for the burst of data traffic is scheduled based on the information indicating a time after the BET but before a latest time at which one or more packets are to be delivered according to a PDB minus an expected transmission time.

In a particular embodiment, the scheduling information comprises a transport block size that accommodates all of a plurality of data packets associated with the burst of data traffic.

In a particular embodiment, the at least one radio resource is associated with a configured grant for periodic uplink traffic.

In another particular embodiment, the at least one radio resource is associated with Semi-Persistent Scheduling for periodic downlink traffic.

In another particular embodiment, the at least one radio resource is associated with a dynamic grant for aperiodic uplink or downlink traffic.

In a particular embodiment, the scheduling of the at least one radio resource for the burst of data traffic based on the information meets a PDB and/or a PER.

In a particular embodiment, the information further comprises at least one of: a flow direction of the traffic or radio traffic flow, a periodicity indicating a time period between two adjacent radio traffic bursts, a burst arrival time indicating a latest possible time when a first packet of a radio traffic burst arrives at an ingress interface of the network node or an egress interface of the wireless device.

FIG. 14 illustrates a schematic block diagram of a virtual apparatus 1100 in a wireless network (for example, the wireless network shown in FIG. 2). The apparatus may be implemented in a wireless device or network node (e.g., wireless device 110 or network node 160 shown in FIG. 2). Apparatus 1100 is operable to carry out the example method described with reference to FIG. 13 and possibly any other processes or methods disclosed herein. It is also to be understood that the method of FIG. 13 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module 1110, second receiving module 1120, and any other suitable units of apparatus 1100 to perform corresponding functions according one or more embodiments of the present disclosure.

According to certain embodiments, first receiving module 1110 may perform certain of the receiving functions of the apparatus 1100. For example, first receiving module 1110 may receive, from a network node 160, information indicating a BET for a burst of data traffic within a traffic or radio traffic flow.

According to certain embodiments, second receiving module 1120 may perform certain of the receiving functions of the apparatus 1100. For example, second receiving module 1120 may receive the burst of data traffic.

As used herein, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

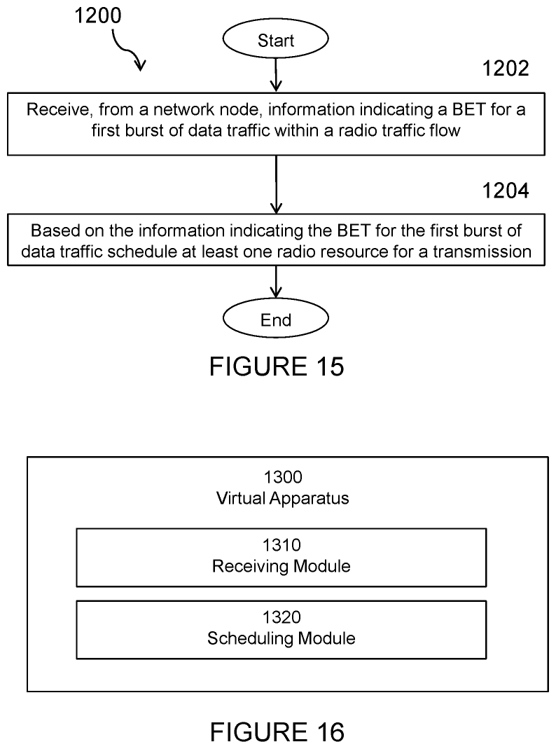

FIG. 15 depicts a method 1200 by a radio access network (RAN) node such as network node 160, according to certain embodiments. At step 1202, the RAN node receives, from a network node, information indicating a BET for a first burst of data traffic within a traffic or radio traffic flow. At step 1204, based on the information indicating the BET for the first burst of data traffic, the RAN node schedules at least one radio resource for a transmission.

In a particular embodiment, the network node is a core network node or a network node comprising a core network function.

In a particular embodiment, the RAN node aggregates packets associated with the burst of data traffic and transmits the aggregated packets associated with the burst of data traffic based on the scheduling of at least one radio resource.

In a particular embodiment, the RAN node transmits scheduling information to the wireless device, and the scheduling information indicates the at least one radio resource scheduled for a transmission by the wireless device and/or wherein transmitting the aggregated packets comprises transmitting the aggregated packets to the wireless device.

In a particular embodiment, the RAN node transmits the transmission to a wireless device according to the at least one radio resource.

In a particular embodiment, the information comprises TSCAI associated with a TSC. In a further particular embodiment, the TSC is associated with at least one TSN service.

In a particular embodiment, the traffic or radio traffic flow comprises a plurality of bursts of data traffic, and the burst of data traffic comprises a first burst of data traffic within the plurality of bursts of data traffic. In a further particular embodiment, the plurality of bursts of data traffic make up a periodic burst cycle.

In a further particular embodiment, based on the BET for the first burst of data traffic, the RAN node determines a BET for each burst of data traffic within the plurality of bursts of data traffic.

In a particular embodiment, the traffic or radio traffic flow comprises a Quality of Service flow.

In a particular embodiment, based on the information comprising the BET, the RAN node determines a latest point in time when a packet is to be included in the transmission associated with the at least one radio resource.

In a particular embodiment, the BET is a latest time when no additional packets can arrive at an ingress interface of the network node for transmission on the downlink or an egress interface of the wireless device for transmission on the uplink.

In a particular embodiment, the BET is a latest time when a last packet in the burst is estimated to arrive within a radio network system comprising the radio access network node and a time duration estimated for the last packet to arrive at the radio access network node.

In a particular embodiment, the BET further comprises an amount of time associated with jitter.

In a particular embodiment, the at least one radio resource for the burst of data traffic within the traffic or radio traffic flow is scheduled based on the information at a time corresponding to the BET.

In a particular embodiment, the at least one radio resource for the burst of data traffic within the traffic or radio traffic flow is scheduled based on the information at a time after the BET.

In a particular embodiment, the at least one radio resource for the burst of data traffic is scheduled based on the information indicating a time after the BET but before a latest time at which one or more packets are to be delivered according to a PDB minus an expected transmission time.

In a particular embodiment, the information comprises a transport block size that accommodates all of a plurality of data packets associated with the burst of data traffic.

In a particular embodiment, the at least one radio resource is associated with a configured grant for periodic uplink traffic.

In another particular embodiment, the at least one radio resource is associated with Semi-Persistent Scheduling for periodic downlink traffic.

In another particular embodiment, the at least one radio resource is associated with a dynamic grant for aperiodic uplink or downlink traffic.

In a particular embodiment, the information further comprises at least one of: a flow direction of the traffic or radio traffic flow, a periodicity indicating a time period between two adjacent radio traffic bursts, a burst arrival time indicating a latest possible time when a first packet of the burst of data traffic arrives at an ingress interface of the network node or an egress interface of the wireless device.

In a particular embodiment, the scheduling of the at least one radio resource for the burst of data traffic based on the information meets at least one of: a PDB and a PER.

FIG. 16 illustrates a schematic block diagram of another virtual apparatus 1300 in a wireless network (for example, the wireless network shown in FIG. 2). The apparatus may be implemented in a wireless device or network node (e.g., wireless device 110 or network node 160 shown in FIG. 2). Apparatus 1300 is operable to carry out the example method described with reference to FIG. 15 and possibly any other processes or methods disclosed herein. It is also to be understood that the method of FIG. 15 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310, scheduling module 1320, and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a network node, information indicating a BET for a first burst of data traffic within a traffic or radio traffic flow. At step N04, based on the information indicating the BET for the first burst of data traffic, the RAN node schedules at least one radio resource for a transmission.

According to certain embodiments, scheduling module 1320 may perform certain of the scheduling functions of the apparatus 1300. For example, based on the information indicating the BET for the first burst of data traffic, the scheduling module 1320 may schedule at least one radio resource for a transmission.

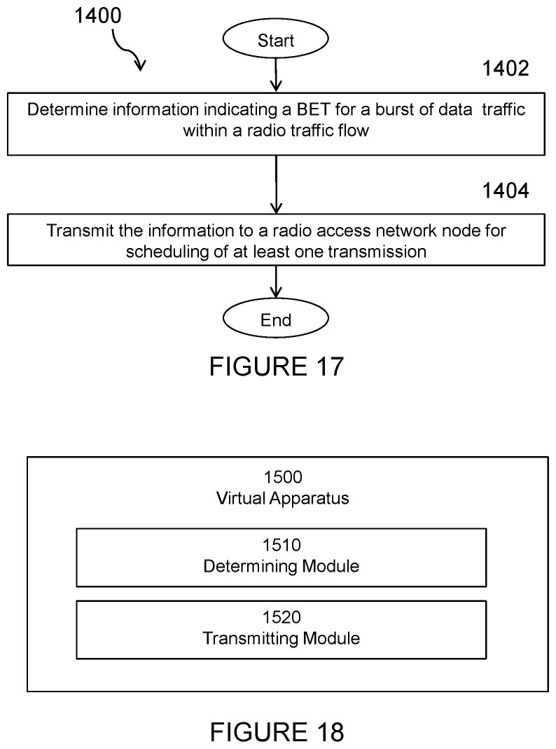

FIG. 17 depicts a method 1400 by a network node 160, according to certain embodiments. At step 1402, the network node determines information indicating a BET for a burst of data traffic within a traffic or radio traffic flow. At step 1404, the network node transmits the information to a radio access network node for scheduling of at least one transmission.

In a particular embodiment, the network node is a core network node or a network node comprising a core network function.

In a particular embodiment, the information comprises TSCAI associated with a TSC. In a further particular embodiment, the TSC is associated with at least one TSN service.

In a particular embodiment, the traffic or radio traffic flow comprises a plurality of bursts of data traffic, and the burst of data traffic comprises a first burst of data traffic within the plurality of bursts of data traffic. In a further particular embodiment, the plurality of bursts of data traffic make up a periodic burst cycle. In a further particular embodiment, the traffic or radio traffic flow comprises a Quality of Service flow.

In a further particular embodiment, based on the BET for the first burst of data traffic, the network node determines a BET for each burst of data traffic within the plurality of bursts of data traffic.

In a particular embodiment, when determining the BET for the burst of data traffic, the network node determines the BET for the burst of data traffic for transmission on a downlink to a wireless device.

In a particular embodiment, when determining the information indicating the BET for the burst of data traffic, the network node receives the BET for the burst of data traffic for transmission on an uplink by the wireless device.

In a particular embodiment, based on the information comprising the BET, the network node determines a latest point in time when a packet is to be included in the transmission.

In a particular embodiment, the BET is a latest time when no more data can arrive at an ingress interface of the network node for transmission on the downlink to a wireless device or an egress interface of the wireless device for transmission on the uplink from the wireless device to the network node.

In a particular embodiment, the BET is a latest time when a last packet in the burst of data traffic is estimated to arrive at a radio network system that comprises the radio access node and the network node and a time duration estimated for the last packet to arrive at the network node.

In a particular embodiment, the BET further comprises an amount of time associated with jitter.

In a particular embodiment, the information further includes at least one of: a flow direction of the traffic or radio traffic flow, a periodicity indicating a time period between two adjacent radio traffic bursts, a burst arrival time indicating a latest possible time when a first packet of the burst of data traffic arrives at an ingress interface of the network node or an egress interface of a wireless device.

FIG. 18 illustrates a schematic block diagram of another virtual apparatus 1500 in a wireless network (for example, the wireless network shown in FIG. 2). The apparatus may be implemented in a wireless device or network node (e.g., wireless device 110 or network node 160 shown in FIG. 2). Apparatus 1500 is operable to carry out the example method described with reference to FIG. 17 and possibly any other processes or methods disclosed herein. It is also to be understood that the method of FIG. 17 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1510, transmitting module 1520, and any other suitable units of apparatus 1500 to perform corresponding functions according one or more embodiments of the present disclosure.

According to certain embodiments, determining module 1510 may perform certain of the determining functions of the apparatus 1500. For example, determining module 1510 may determine information indicating a BET for a burst of data traffic within a traffic or radio traffic flow.

According to certain embodiments, transmitting module 1520 may perform certain of the transmitting functions of the apparatus 1500. For example, transmitting module 1520 may transmit the information to a radio access network node for scheduling of at least one transmission.

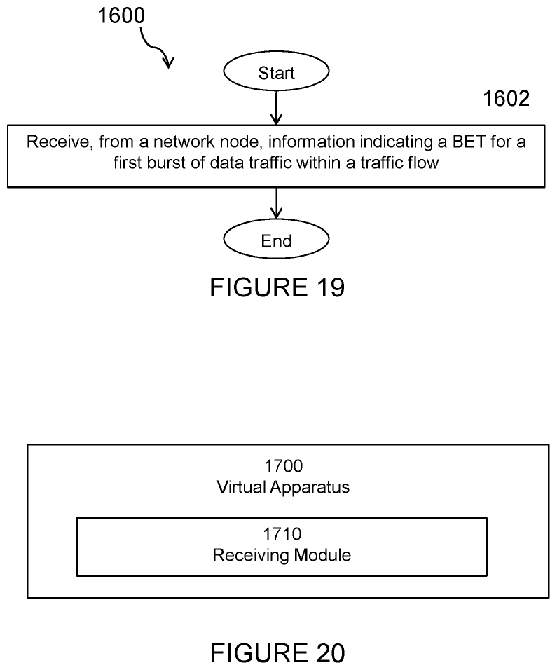

FIG. 19 depicts a method 1600 by a radio network node 160, according to certain embodiments. At step 1602, the radio network node receives, from a network node, information indicating a BET for a burst of data traffic within a traffic flow.

In a particular embodiment, the radio network node schedules at least one radio resource for a transmission based on the information indicating the BET for the first burst of data traffic.

In a particular embodiment, the radio network node aggregates packets associated with the burst of data traffic and transmits the aggregated packets associated with the burst of data traffic based on the scheduling of the at least one radio resource.

In a further particular embodiment, aggregating the packets associated with the burst of data traffic comprises aggregating the packets into a single MAC PDU.

In a particular embodiment, the radio network node transmits scheduling information to the wireless device, the scheduling information indicating the at least one radio resource scheduled for the transmission by the radio access network node to the wireless device.

In a particular embodiment, the at least one radio resource for the burst of data traffic within the traffic flow is scheduled based on: information indicating a time after the BET, or information indicating a time after the BET but before a latest time at which one or more packets are to be delivered according to a packet delay budget, PDB, minus an expected transmission time.

In a particular embodiment, the scheduling of the at least one radio resource for the burst of data traffic based on the information meets at least one of: a PDB and a PER.

In a particular embodiment, the radio access network node comprises a gNodeB and/or the network node comprises a core network node or a network node comprising a core network function.

In a particular embodiment, the traffic flow comprises a QoS flow.

In a particular embodiment, the radio network node transmits the information to a wireless device according to the at least one radio resource.

In a particular embodiment, the information includes TSCAI associated with a TSC and the TSC is associated with at least one TSN service.

In a particular embodiment, the traffic flow includes a plurality of bursts of data traffic, and the burst of data traffic includes a first burst of data traffic within the plurality of bursts of data traffic.

In a further particular embodiment, based on the BET for the first burst of data traffic, the radio network node determines a BET for each burst of data traffic within the plurality of bursts of data traffic. The plurality of bursts of data traffic make up a periodic burst cycle.

In a particular embodiment, based on the BET for the first burst of data traffic, the radio network node determines a BET for each burst of data traffic within the plurality of bursts of data traffic.

In a particular embodiment, based on the information comprising the BET, the radio network node determines a latest point in time when a packet is to be included in the transmission associated with the at least one radio resource.

In a particular embodiment, the BET includes a latest time when no additional packets can arrive at an ingress interface of the radio access network node for transmission on the downlink or an egress interface of the wireless device for inclusion in the transmission associated with the at least one radio resource.

In a particular embodiment, the at least one radio resource for the burst of data traffic is scheduled based on the information indicating a time after the BET but before a latest time at which one or more packets are to be delivered according to a PDB minus an expected transmission time.

In a particular embodiment, the information comprises a transport block size that accommodates all of a plurality of data packets associated with the burst of data traffic.

In a particular embodiment, the at least one radio resource is associated with a configured grant for periodic uplink traffic.

In a particular embodiment, the at least one radio resource is associated with Semi-Persistent Scheduling for periodic downlink traffic.

In a particular embodiment, the at least one radio resource is associated with a dynamic grant for aperiodic uplink or downlink traffic.

In a particular embodiment, the information further comprises at least one of: a flow direction of the traffic flow, a periodicity indicating a time period between two adjacent radio traffic bursts, a burst arrival time indicating a latest possible time when a first packet of the burst of data traffic arrives at an ingress interface of the network node or an egress interface of the wireless device.

In a particular embodiment, the scheduling of the at least one radio resource for the burst of data traffic based on the information meets at least one of: a PDB and a PER.

In a particular embodiment, the radio network node—includes processing circuitry configured to perform any of the methods and steps described above.

In a particular embodiment, a computer program includes instructions which when executed on a computer perform any of the methods and steps described above.

In a particular embodiment, a computer program product includes a computer program that includes instructions which when executed on a computer perform any of the methods or steps described above.

In a particular embodiment, a non-transitory computer readable medium stores instructions which when executed by a computer perform any of the methods and steps described above.

FIG. 20 illustrates a schematic block diagram of a virtual apparatus 1700 in a wireless network (for example, the wireless network shown in FIG. 2). The apparatus may be implemented in a wireless device or network node (e.g., wireless device 110 or network node 160 shown in FIG. 2). Apparatus 1700 is operable to carry out the example method described with reference to FIG. 19 and possibly any other processes or methods disclosed herein. It is also to be understood that the method of FIG. 19 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1710 and any other suitable units of apparatus 1700 to perform corresponding functions according one or more embodiments of the present disclosure.

According to certain embodiments, receiving module 1710 may perform certain of the receiving functions of the apparatus 1700. For example, receiving module 1710 may receive, from a network node, information indicating a BET for a burst of data traffic within a traffic flow.

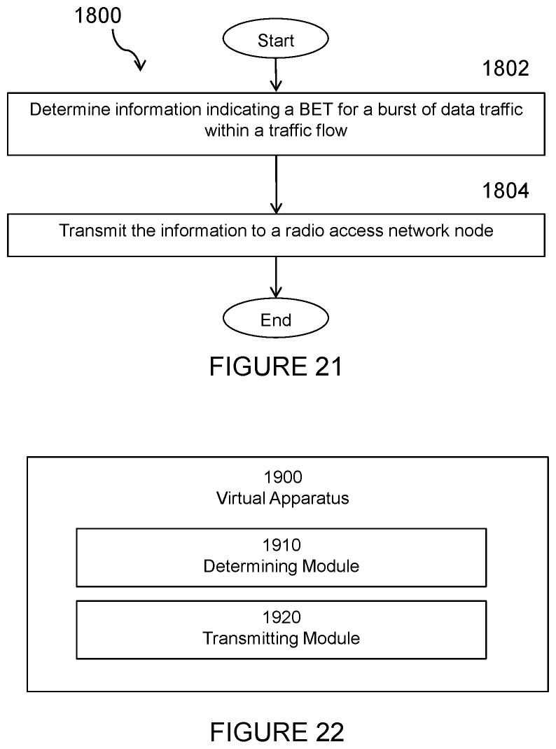

FIG. 21 depicts another method 1800 by a network node 160, according to certain embodiments. At step 1802, the network node determines information indicating a BET for a burst of data traffic within a traffic flow. At step 1804, the network node transmits the information to a radio access network node.

In a particular embodiment, the radio access network node comprises a gNodeB and/or the network node comprises a core network node or a network node comprising a core network function.

In a particular embodiment, the traffic flow comprises a QoS flow.

In a particular embodiment, the information comprises TSCAI associated with a TS,C and the TSC is associated with at least one TSN service.

In a particular embodiment, the traffic flow includes a plurality of bursts of data traffic, and the burst of data traffic includes a first burst of data traffic within the plurality of bursts of data traffic. The plurality of bursts of data traffic make up a periodic burst cycle.

In a particular embodiment, based on the BET for the first burst of data traffic, the network node determines a BET for each burst of data traffic within the plurality of bursts of data traffic.

In a particular embodiment, determining the BET for the burst of data traffic includes determining, by the network node, the BET for the burst of data traffic for transmission on a downlink to a wireless device.

In a particular embodiment, based on the information comprising the BET, the network node determines a latest point in time when a packet is to be included in the transmission.

In a particular embodiment, the BET is a latest time when no more data can arrive at an ingress interface of the radio access network node for transmission on the downlink to a wireless device or an egress interface of the wireless device for inclusion in a transmission.

In a particular embodiment, the BET is a latest time when a last packet in the burst of data traffic is estimated to arrive at the core network and a time duration estimated for the last packet to arrive at the radio network node.

In a particular embodiment, the BET includes an amount of time associated with jitter.

In a particular embodiment, the network node includes processing circuitry configured to perform any of the methods and steps described above.

In a particular embodiment, a computer program includes instructions which when executed on a computer perform any of the methods and steps described above.

In a particular embodiment, a computer program product includes a computer program that includes instructions which when executed on a computer perform any of the methods or steps described above.

In a particular embodiment, a non-transitory computer readable medium stores instructions which when executed by a computer perform any of the methods and steps described above.

FIG. 22 illustrates a schematic block diagram of another virtual apparatus 1900 in a wireless network (for example, the wireless network shown in FIG. 2). The apparatus may be implemented in a wireless device or network node (e.g., wireless device 110 or network node 160 shown in FIG. 2). Apparatus 1900 is operable to carry out the example method described with reference to FIG. 21 and possibly any other processes or methods disclosed herein. It is also to be understood that the method of FIG. 21 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1910, transmitting module 1920, and any other suitable units of apparatus 1900 to perform corresponding functions according one or more embodiments of the present disclosure.

According to certain embodiments, determining module 1910 may perform certain of the determining functions of the apparatus 1900. For example, determining module 1910 may determine information indicating a BET for a burst of data traffic within a traffic flow.

According to certain embodiments, transmitting module 1920 may perform certain of the transmitting functions of the apparatus 1900. For example, transmitting module 1920 may transmit the information to a radio access network node.

### EXAMPLE EMBODIMENTS

### Group A Example Embodiments

Example A1. A method by a wireless device comprising: receiving, from a network node, information indicating a burst end time (BET) for a burst of data traffic within a traffic or radio traffic flow, and receiving the burst of data traffic.
Example A2. The method of Example Embodiment A1, further comprising aggregating packets received within the burst of data traffic.
Example A3. The method of any one of Example Embodiments A1 to A2, wherein the information comprises Time Sensitive Communication Assistance Information (TSCAI) associated with a Time Sensitive Communications (TSC).
Example A4. The method of Example Embodiment A3, wherein the TSC is associated with at least one Time Sensitive Networking (TSN) service.
Example A5. The method of any one of Example Embodiments A1 to A4, wherein the traffic or radio traffic flow comprises a plurality of bursts of data traffic, and wherein the burst of data traffic comprises a first burst of data traffic within the plurality of bursts of data traffic.
Example A6. The method of Example Embodiment A5, wherein the plurality of bursts of data traffic make up a periodic burst cycle.
Example A7. The method of any one of Example Embodiments A5 to A6, wherein the traffic or radio traffic flow comprises a Quality of Service flow.
Example A8. The method of any one of Example Embodiments A5 to A7, wherein the method further comprises: based on the BET for the first burst of data traffic, determining a BET for each burst of data traffic within the plurality of bursts of data traffic.
Example A9. The method of any one of Example Embodiments A1 to A8, wherein the BET comprises a latest time when no additional packets can arrive at an ingress interface of the network node for transmission on the downlink or an egress interface of the wireless device for transmission on the uplink.
Example A10. The method of any one of Example Embodiments A1 to A8, wherein the BET comprises: a latest time when a last packet in the burst is estimated to arrive at the radio network system, and a time duration estimated for the last packet to arrive at the network node.
Example A11. The method of any one of Example Embodiments A1 to A10, wherein the BET further comprises an amount of time associated with jitter.
Example A12. The method of any one of Example Embodiments A1 to A11, further comprising: receiving, from the network node, scheduling information comprising at least one radio resource for receiving the burst of data traffic based on the BET.
Example A13. The method of Example Embodiment A12, further comprising: based on the information comprising the BET, determining a latest point in time when a packet is to be included in a transmission associated with the at least one radio resource.
Example A14. The method of any one of Example Embodiments A12 to A13, wherein the at least one radio resource for the burst of data traffic within the traffic or radio traffic flow is scheduled based on the information at a time corresponding to the BET.
Example A15. The method of any one of Example Embodiments A12 to A13, wherein the at least one radio resource for the burst of data traffic within the traffic or radio traffic flow is scheduled based on the information at a time after the BET.
Example A16. The method of any one of Example Embodiments A12 to A13, wherein the at least one radio resource for the burst of data traffic is scheduled based on the information at a time after the BET but before a latest time at which one or more packets are to be delivered according to a packet delay budget (PDB) minus an expected transmission time.
Example A17. The method of any one of Example Embodiments A12 to A16, wherein the scheduling information comprises a transport block size that accommodates all of a plurality of data packets associated with the burst of data traffic.
Example A18. The method of any one of Example Embodiments A12 to A17, wherein the at least one radio resource is associated with a configured grant for periodic uplink traffic.
Example A19. The method of any one of Example Embodiments A12 to A17, wherein the at least one radio resource is associated with Semi-Persistent Scheduling for periodic downlink traffic.
Example A20. The method of any one of Example Embodiments A12 to A17, wherein the at least one radio resource is associated with a dynamic grant for aperiodic uplink or downlink traffic.
Example A21. The method of any one of Example Embodiments A12 to A20 wherein the scheduling of the at least one radio resource for the burst of data traffic based on the information meets at least one of: a Packet Delay Budget (PDB) and a Packet Error Rate (PER).
Example A22. The method of any one of Example Embodiments A1 to A21, wherein the information further comprises at least one of: a flow direction of the traffic or radio traffic flow, a periodicity indicating a time period between two adjacent radio traffic bursts, a burst arrival time indicating a latest possible time when a first packet of a radio traffic burst arrives at an ingress interface of the network node or an egress interface of the wireless device.
Example A23. A wireless device comprising processing circuitry configured to perform any of the methods of Example Embodiments A1 to A22.
Example A24. A computer program comprising instructions which when executed on a computer perform any of the methods of Example Embodiments A1 to A22.
Example A25. A computer program product comprising computer program, the computer program comprising instructions which when executed on a computer perform any of the methods of Example Embodiments A1 to A22.
Example A26. A non-transitory computer readable medium storing instructions which when executed by a computer perform any of the methods of Example Embodiments A1 to A22.

### Group B Embodiments

Example B1. A method by a radio access network node comprising: receiving, from a network node, information indicating a burst end time (BET) for a first burst of data traffic within a traffic or radio traffic flow; and based on the information indicating the BET for the first burst of data traffic, scheduling at least one radio resource for a transmission.
Example B2. The method of Example Embodiment B1, further comprising: aggregating packets associated with the burst of data traffic; and transmitting the aggregated packets associated with the burst of data traffic based on the scheduling of at least one radio resource.
Example 133. The method of Example Embodiment B1 or B2, further comprising transmitting scheduling information to the wireless device, the scheduling information indicating the at least one radio resource scheduled for a transmission by the radio access network node to the wireless device, and/or wherein transmitting the aggregated packets comprises transmitting the aggregated packets to the wireless device.
Example B4. The method of Example Embodiment B1, further comprising transmitting the transmission to a wireless device according to the at least one radio resource.
Example B5. The method of any one of Example Embodiments B1 to B4, wherein the information comprises Time Sensitive Communication Assistance Information (TSCAI) associated with a Time Sensitive Communications (TSC).
Example B6. The method of Example Embodiment B5, wherein the TSC is associated with at least one Time Sensitive Networking (TSN) service.
Example B7. The method of any one of Example Embodiments B1 to B6, wherein the traffic or radio traffic flow comprises a plurality of bursts of data traffic, and wherein the burst of data traffic comprises a first burst of data traffic within the plurality of bursts of data traffic.
Example B8. The method of Example Embodiment B6, wherein the plurality of bursts of data traffic make up a periodic burst cycle.
Example B9. The method of any one of Example Embodiments B5 to BR, wherein the method further comprises: based on the BET for the first burst of data traffic, determining a BET for each burst of data traffic within the plurality of bursts of data traffic.
Example B10. The method of any one of Example Embodiments B1 to B9, wherein the traffic or radio traffic flow comprises a Quality of Service flow.
Example B11. The method of any one of Example Embodiments B1 to B10, further comprising: based on the information comprising the BET, determining a latest point in time when a packet is to be included in the transmission associated with the at least one radio resource.
Example B12. The method of any one of Example Embodiments B1 to B10, wherein the BET comprises a latest time when no additional packets can arrive at an ingress interface of the network node for transmission on the downlink or an egress interface of the wireless device for transmission on the uplink.
Example B13. The method of any one of Example Embodiments B1 to B10, wherein the BET comprises: a latest time when a last packet in the burst is estimated to arrive within a radio network system comprising the radio access network node, and a time duration estimated for the last packet to arrive at the radio access network node.
Example B14. The method of any one of Example Embodiments B1 to B13, wherein the BET further comprises an amount of time associated with jitter.
Example B15. The method of any one of Example Embodiments B1 to B14, wherein the at least one radio resource for the burst of data traffic within the traffic or radio traffic flow is scheduled based on the information at a time corresponding to the BET.
Example B16. The method of any one of Example Embodiments B1 to B14, wherein the at least one radio resource for the burst of data traffic within the traffic or radio traffic flow is scheduled based on the information at a time after the BET.
Example B17. The method of any one of Example Embodiments B1 to B14, wherein the at least one radio resource for the burst of data traffic is scheduled based on the information at a time after the BET but before a latest time at which one or more packets are to be delivered according to a packet delay budget (PDB) minus an expected transmission time.
Example B18. The method of any one of Example Embodiments B1 to B17, wherein the information comprises a transport block size that accommodates all of a plurality of data packets associated with the burst of data traffic.
Example B19. The method of any one of Example Embodiments B1 to B18, wherein the at least one radio resource is associated with a configured grant for periodic uplink traffic.
Example B20. The method of any one of Example Embodiments B1 to B18, wherein the at least one radio resource is associated with Semi-Persistent Scheduling for periodic downlink traffic.
Example B21. The method of any one of Example Embodiments B1 to B18, wherein the at least one radio resource is associated with a dynamic grant for aperiodic uplink or downlink traffic.
Example B22. The method of any one of Example Embodiments B1 to B21, wherein the information further comprises at least one of: a flow direction of the traffic or radio traffic flow, a periodicity indicating a time period between two adjacent radio traffic bursts, a burst arrival time indicating a latest possible time when a first packet of the burst of data traffic arrives at an ingress interface of the network node or an egress interface of the wireless device.
Example B23. The method of any one of Example Embodiments B1 to B22 wherein the scheduling of the at least one radio resource for the burst of data traffic based on the information meets at least one of: a Packet Delay Budget (PDB) and a Packet Error Rate (PER).
Example B24. The method of any one of Example Embodiments B1 to B23 wherein the network node is a core network node or a network node comprising a core network function.
Example B25. A network node comprising processing circuitry configured to perform any of the methods of Example Embodiments B1 to B24.
Example B26. A computer program comprising instructions which when executed on a computer perform any of the methods of Example Embodiments B1 to B24.
Example B27. A computer program product comprising computer program, the computer program comprising instructions which when executed on a computer perform any of the methods of Example Embodiments B1 to B24.
Example B28. A non-transitory computer readable medium storing instructions which when executed by a computer perform any of the methods of Example Embodiments B1 to B24.

### Group C Embodiments

Example C1. A method performed by a network node, the method comprising: determining information indicating a burst end time (BET) for a burst of data traffic within a traffic or radio traffic flow; and transmitting the information to a radio access network node for scheduling of at least one transmission.
Example C2. The method of Example Embodiment C1, wherein the information comprises Time Sensitive Communication Assistance Information (TSCAI) associated with a Time Sensitive Communications (TSC).
Example C3. The method of Example Embodiment C2, wherein the TSC is associated with at least one Time Sensitive Networking (TSN) service.
Example C4. The method of any one of Example Embodiments C1 to C3, wherein the traffic or radio traffic flow comprises a plurality of bursts of data traffic, and wherein the burst of data traffic comprises a first burst of data traffic within the plurality of bursts of data traffic.
Example C5. The method of Example Embodiment C4, wherein the plurality of bursts of data traffic make up a periodic burst cycle.
Example C6. The method of any one of Example Embodiments C4 to C5, wherein the traffic or radio traffic flow comprises a Quality of Service flow.
Example C7. The method of any one of Example Embodiments C4 to C6, wherein the method further comprises: based on the BET for the first burst of data traffic, determining a BET for each burst of data traffic within the plurality of bursts of data traffic.
Example C8. The method of any one of Example Embodiments C1 to C7, wherein determining the BET for the burst of data traffic comprises: determining, by the network node, the BET for the burst of data traffic for transmission on a downlink to a wireless device.
Example C9. The method of any one of Example Embodiments C1 to C7, wherein determining the information indicating the BET for the burst of data traffic comprises: receiving the BET for the burst of data traffic for transmission on an uplink by the wireless device.
Example C10. The method of any one of Example Embodiments C1 to C9, further comprising: based on the information comprising the BET, determining a latest point in time when a packet is to be included in the transmission.
Example C11. The method of any one of Example Embodiments C1 to C10, wherein the BET comprises a latest time when no more data can arrive at an ingress interface of the network node for transmission on the downlink to a wireless device or an egress interface of the wireless device for transmission on the uplink from the wireless device to the network node.
Example C12. The method of any one of Example Embodiments, C1 to C10, wherein the BET comprises: a latest time when a last packet in the burst of data traffic is estimated to arrive at a radio network system that comprises the radio access node and the network node, and a time duration estimated for the last packet to arrive at the network node.
Example C13. The method of any one of Example Embodiments C1 to C12, wherein the BET comprises an amount of time associated with jitter.
Example C14. The method of any one of Example Embodiments C1 to C13, wherein the information further comprises at least one of: a flow direction of the traffic or radio traffic flow, a periodicity indicating a time period between two adjacent radio traffic bursts, a burst arrival time indicating a latest possible time when a first packet of the burst of data traffic arrives at an ingress interface of the network node or an egress interface of a wireless device.
Example C15. The method of any one of Example Embodiments C1 to C14 wherein the network node is a core network node or a network node comprising a core network function.
Example C16. A network node comprising processing circuitry configured to perform any of the methods of Example Embodiments C1 to C15.
Example C17. A computer program comprising instructions which when executed on a computer perform any of the methods of Example Embodiments C1 to C15.
Example C18. A computer program product comprising computer program, the computer program comprising instructions which when executed on a computer perform any of the methods of Example Embodiments C1 to C15.
Example C19. A non-transitory computer readable medium storing instructions which when executed by a computer perform any of the methods of Example Embodiments C1 to C15.

### Group D Example Embodiments

Example D1. A wireless device comprising: processing circuitry configured to perform any of the steps of any of the Group A Example Embodiments; and power supply circuitry configured to supply power to the wireless device.
Example D2. A network node comprising: processing circuitry configured to perform any of the steps of any of the Group B and C Example Embodiments; power supply circuitry configured to supply power to the wireless device. Example D3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.
Example D4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B and C Example Embodiments.
Example D5. The communication system of the pervious embodiment further including the network node.
Example D6. The communication system of the previous 2 embodiments, further including the wireless device, wherein the wireless device is configured to communicate with the network node.
Example D7. The communication system of the previous 3 embodiments, wherein: the processing circuitry of the host computer is configured to execute a host application, thereby providing the user data; and the wireless device comprises processing circuitry configured to execute a client application associated with the host application.
Example D8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B and C Example Embodiments.
Example D9. The method of the previous embodiment, further comprising, at the network node, transmitting the user data.
Example D10. The method of the previous 2 embodiments, wherein the user data is provided at the host computer by executing a host application, the method further comprising, at the wireless device, executing a client application associated with the host application.
Example D11. A wireless device configured to communicate with a network node, the wireless device comprising a radio interface and processing circuitry configured to performs the of the previous 3 embodiments.
Example D12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A Example Embodiments.
Example D13. The communication system of the previous embodiment, wherein the cellular network further includes a network node configured to communicate with the wireless device.
Example D14. The communication system of the previous 2 embodiments, wherein: the processing circuitry of the host computer is configured to execute a host application, thereby providing the user data; and the wireless device's processing circuitry is configured to execute a client application associated with the host application.
Example D15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A Example Embodiments.
Example D16. The method of the previous embodiment, further comprising at the wireless device, receiving the user data from the network node.
Example D17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A Example Embodiments.
Example D18. The communication system of the previous embodiment, further including the wireless device.
Example D19. The communication system of the previous 2 embodiments, further including the network node, wherein the network node comprises a radio interface configured to communicate with the wireless device and a communication interface configured to forward to the host computer the user data carried by a transmission from the wireless device to the network node.
Example D20. The communication system of the previous 3 embodiments, wherein: the processing circuitry of the host computer is configured to execute a host application; and the wireless device's processing circuitry is configured to execute a client application associated with the host application, thereby providing the user data.
Example D21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.
Example D22. A method implemented in a communication system including a host computer, a network node and a wireless device, the method comprising: at the host computer, receiving user data transmitted to the network node from the wireless device, wherein the wireless device performs any of the steps of any of the Group A Example Embodiments.
Example D23. The method of the previous embodiment, further comprising, at the wireless device, providing the user data to the network node.
Example D24. The method of the previous 2 embodiments, further comprising: at the wireless device, executing a client application, thereby providing the user data to be transmitted; and at the host computer, executing a host application associated with the client application.
Example D25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.
Example D26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B and C Example Embodiments.
Example D27. The communication system of the previous embodiment further including the network node.
Example D28. The communication system of the previous 2 embodiments, further including the wireless device, wherein the wireless device is configured to communicate with the network node.
Example D29. The communication system of the previous 3 embodiments, wherein: the processing circuitry of the host computer is configured to execute a host application; the wireless device is configured to execute a client application associated with the host application, thereby providing the user data to be received by the host computer.
Example D30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A Example Embodiments.
Example D31. The method of the previous embodiment, further comprising at the network node receiving the user data from the wireless device.
Example D32. The method of the previous 2 embodiments, further comprising at the network node, initiating a transmission of the received user data to the host computer.
Example D33. The method of any of the previous embodiments, wherein the network node comprises a base station.
Example D34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from this disclosure.

1.-32. (canceled)

33. A method by a radio access network node comprising:
receiving, from a network node, information indicating a burst end time, BET, for a first burst of data traffic within a traffic flow.

34. The method of claim 33, further comprising scheduling at least one radio resource for a transmission based on the information indicating the BET for the first burst of data traffic.

35. The method of claim 34, further comprising:
aggregating packets associated with the burst of data traffic; and
transmitting the aggregated packets associated with the burst of data traffic based on the scheduling of the at least one radio resource.

36. The method of claim 35, wherein aggregating the packets associated with the burst of data traffic comprises aggregating the packets into a single Medium Access Control Protocol Data Unit, MAC PDU.

37. The method of claim 34, further comprising transmitting scheduling information to a wireless device, the scheduling information indicating the at least one radio resource scheduled for the transmission by the radio access network node to the wireless device.

38. The method of claim 34, wherein the at least one radio resource for the burst of data traffic within the traffic flow is scheduled based on:
the information at a time after the BET,
the information at a time after the BET but before a latest time at which one or more packets are to be delivered according to a packet delay budget, PDB, minus an expected transmission time, or
the information at a time after the BET but before a latest time at which one or more packets are to be delivered according to a packet delay budget, PDB, minus an expected transmission time.

39. The method of claim 33, wherein the information comprises Time Sensitive Communication Assistance Information, TSCAI, associated with a Time Sensitive Communications, TSC, and wherein the TSC is associated with at least one Time Sensitive Networking, TSN, service.

40. The method of claim 33, wherein the traffic flow comprises a plurality of bursts of data traffic, and wherein the burst of data traffic comprises a first burst of data traffic within the plurality of bursts of data traffic.

41. A method performed by a network node, the method comprising:
determining information indicating a burst end time, BET, for a burst of data traffic within a traffic flow; and
transmitting the information to a radio access network node.

42. The method of claim 41, wherein the information comprises Time Sensitive Communication Assistance Information, TSCAI, associated with a Time Sensitive Communications, TSC, and wherein the TSC is associated with at least one Time Sensitive Networking, TSN, service.

43. The method of claim 41, wherein the traffic flow comprises a plurality of bursts of data traffic, and wherein the burst of data traffic comprises a first burst of data traffic within the plurality of bursts of data traffic, and wherein the plurality of bursts of data traffic make up a periodic burst cycle.

44. The method of claim 41, wherein the BET comprises:
a latest time when a last packet in the burst of data traffic is estimated to arrive at the core network, and
a time duration estimated for the last packet to arrive at the radio network node.

45. The method of claim 41, wherein the BET comprises an amount of time associated with jitter.

46. A radio access network node adapted to:
receive, from a network node, information indicating a burst end time, BET, for a first burst of data traffic within a traffic flow.

47. The radio access network node of claim 46, further adapted to schedule at least one radio resource for a transmission based on the information indicating the BET for the first burst of data traffic.

48. The radio access network node of claim 47, further adapted to:
aggregate packets associated with the burst of data traffic; and
transmit the aggregated packets associated with the burst of data traffic based on the scheduling of the at least one radio resource.

49. The radio access network node of claim 46, wherein the packets are aggregated into a single Medium Access Control Protocol Data Unit, MAC PDU.

50. The radio access network node of claim 46, further adapted to transmit scheduling information to the wireless device, the scheduling information indicating the at least one radio resource scheduled for the transmission by the radio access network node to the wireless device.

51. The radio access network node of claim 46, wherein the at least one radio resource for the burst of data traffic within the traffic flow is scheduled based on:
the information at a time after the BET,
the information at a time after the BET but before a latest time at which one or more packets are to be delivered according to a packet delay budget (PDB) minus an expected transmission time, or
the information at a time after the BET but before a latest time at which one or more packets are to be delivered according to a packet delay budget (PDB) minus an expected transmission time.

52. The radio access network node of claim 46, wherein the information comprises Time Sensitive Communication Assistance Information, TSCAI, associated with a Time Sensitive Communications, TSC, and the TSC is associated with at least one Time Sensitive Networking, TSN, service.

53. A network node adapted to:
determine information indicating a burst end time, BET, for a burst of data traffic within a traffic flow; and
transmit the information to a radio access network node.

54. The network node of claim 53, wherein the information comprises Time Sensitive Communication Assistance Information, TSCAI, associated with a Time Sensitive Communications, TSC, and wherein the TSC is associated with at least one Time Sensitive Networking, TSN, service.
